(19) United States
(12) Patent Application Publication
(10) Pub. No.: US 2018/0189536 A1
(43) Pub. Date: Jul. 5, 2018

(54) QR CODE GENERATION METHOD AND SYSTEM

(71) Applicant: FUJIAN MIKE INTERCONNECTION NETWORK TECHNOLOGY CO., LTD., Fuzhou-city (CN)

(72) Inventors: Haipeng YE, Fuzhou city (CN); Qizhi REN, Fuzhou city (CN); Guanglei CHEN, Fuzhou city (CN); Qiao CHEN, Fuzhou city (CN); Hao LIN, Fuzhou city (CN)

(73) Assignee: FUJIAN MIKE INTERCONNECTION NETWORK TECHNOLOGY CO., LTD., Fuzhou city (CN)

(21) Appl. No.: 15/803,569

(22) Filed: Nov. 3, 2017

(30) Foreign Application Priority Data
Dec. 30, 2016 (CN) 201611252627.1

(51) Int. Cl. G06K 7/14

(52) U.S. Cl. CPC G06K 7/1434; G06Q 50/12; G06K 7/1417

(57) ABSTRACT

The present invention relates to the field of data processing, in particular to a QR code generation method and system. A QR code is generated according to a preset unique code firstly, then corresponding information is bound with the QR code according to user requirements, and thus the QR code can be used more conveniently. In addition, the same QR code can be reused to realize different functions by unbinding or updating the information corresponding to the QR code, and thus the utilization rate of the QR code is increased accordingly.

### CROSS-REFERENCE TO RELATED APPLICATIONS

This application claims the benefit of Chinese Application No. 201611252627.1, filed Dec. 30, 2016, in the State Intellectual Property Office. All disclosures of the document named above is incorporated herein in its entirety by reference.

### TECHNICAL FIELD

The present invention relates to the field of data processing, in particular to a QR code generation method and system.

### DESCRIPTION OF RELATED ART

The patent documentation with the Application No. 201510097188.0 provides an ordering method and system based on a QR code pattern; dining table identification information and menu information are acquired from a preset database, and the dining table identification information is converted into the QR code pattern; a mobile terminal acquires and analyzes the QR code pattern so as to acquire the dining table identification information and the menu information, and the mobile terminal is identified according to the dining table identification information; the ordering service is provided for the identified mobile terminal according to the menu information. By adoption of the ordering method and system based on the QR code pattern, ordering information of a user is directly sent to a backstage kitchen, the trouble of manual ordering is reduced, and the ordering efficiency is effectively improved.

However, in the above scheme, the information carried by the generated QR code pattern cannot be changed, a QR code cannot be reutilized, and the utilization rate is low. In addition, the QR code pattern generated in the above scheme corresponds to the specific dining table identification information and the menu information, a restaurant manager is likely to paste the QR code mistakenly when pasting the QR code onto the corresponding dining table, and consequentially the situation that the QR code does not correspond to dining table information is caused.

### BRIEF SUMMARY OF THE INVENTION

The present invention aims to provide a QR code generation method and system, the utilization rate of QR codes is increased, and the QR codes can be used more conveniently.

For achieving the above technical aim, the following technical scheme is adopted by the present invention:

The present invention provides a QR code generation method which comprises the steps of:

generating a QR code according to a preset unique code;

setting information corresponding to the unique code.

The present invention further provides a QR code generation system which comprises:

a generation module used for generating a QR code according to a preset unique code;

a setting module used for setting information corresponding to the unique code.

The QR code generation method and system of the present invention have the beneficial effects that the QR code is generated according to the preset unique code firstly, then the corresponding information is bound with the QR code according to user requirements, and thus the QR code can be used more conveniently. In addition, by unbinding or updating the information corresponding to the QR code, the same QR code can be reutilized to realize different functions, and the utilization rate of the QR code is increased accordingly.

### BRIEF DESCRIPTION OF THE SEVERAL VIEWS OF THE DRAWINGS

FIG. 1 is a flow block diagram of a specific embodiment of a QR code generation method provided by the present invention;

FIG. 2 is a structure block diagram of a specific embodiment of a QR code generation system provided by the present invention.

Description of Marks:

1. Generation module; 2. Setting module.

### DETAILED DESCRIPTION OF THE INVENTION

For a detailed illustration of the technical content, purposes and effects of the present invention, the following description is given with embodiments and accompanying drawings.

The key concept of the present invention lies in that a QR code is generated according to a preset unique code firstly, then corresponding information is bound with the QR code according to user requirements, in this way, the utilization rate of the QR code is increased, and the QR code can be used more conveniently.

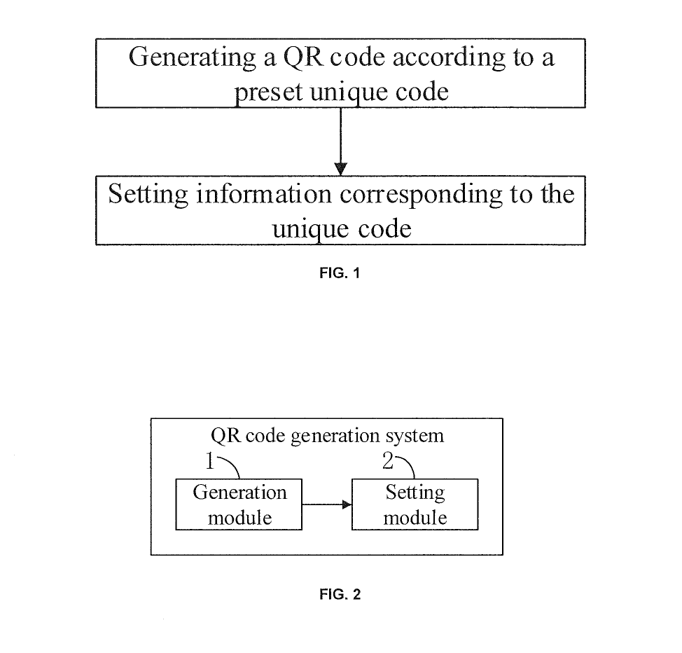

As is shown in FIG. 1, a QR code generation method provided by the present invention comprises the steps of:

generating a QR code according to a preset unique code;

setting information corresponding to the unique code.

Furthermore, the process of generating the QR code according to the preset unique code specifically comprises the steps of:

Obtaining a web link by combining a preset domain name with the unique code;

compiling the web link into the QR code.

According to the above description, the web link includes the domain name and the unique code, and connection between a client side scanning the QR code and a server can be established through the domain name; the client side can acquire different information through different unique codes, and thus the client side can be provided with different services by scanning different QR codes.

Furthermore, the process of setting information corresponding to the unique code specifically comprises the steps of:

setting the unique code as a major key of a preset data table;

setting the value of a field corresponding to the unique code.

According to the above description, the function of the QR code can be set by setting the value of the field corresponding to the unique code.

Furthermore, the field includes a payment field;

the value of the payment field corresponding to the unique code is updated.

According to the above description, the utilization rate of the QR code is increased.

Furthermore, the field includes a restaurant name field and a table number field;

ordering records corresponding to the value of the restaurant name field and the value of the table number field are acquired;

a bill is generated according to the value of the restaurant name field, the value of the table number field and the ordering records.

Furthermore, the method comprises the steps of:

grouping client sides scanning the same QR code;

counting the client sides in the group;

acquiring historical ordering records of all the client sides in the group;

pushing menus to the client sides according to the number of the client sides and the historical ordering records, wherein each menu includes dishes and quantities of the dishes.

According to the above description, a QR code can be pasted onto a dining table, users sharing the same table scan the QR code through the client sides and then are grouped, so that dishes and the corresponding dish quantities are recommended according to the number of the diners sharing the same table and the historical ordering records.

Furthermore, the method comprises the steps of:

grouping client sides scanning the same QR code;

acquiring ordering information of the client sides in the group in real time;

refreshing the ordering information and sending the refreshed ordering information to ordering pages of the client sides.

According to the above description, a QR code can be pasted onto a dining table, users sharing the same dining table scan the QR code through the client sides and then are grouped so that all the users can participate in ordering, the communication time for ordering is shortened, and the ordering efficiency is improved.

The present invention further provides a QR code generation system which comprises:

a generation module 1 used for generating a QR code according to a preset unique code;

a setting module 2 used for setting information corresponding to the unique code.

The QR code generation system further comprises:

an establishment module used for grouping client sides scanning the same QR code;

a counting module used for counting the client sides in the group;

a first acquisition module used for acquiring historical ordering records of the client sides in the group;

a pushing module used for pushing menus to the client sides according to the number of the client sides and the historical ordering records, wherein each menu includes dishes and quantities of the dishes;

a second acquisition module used for acquiring ordering information of the client sides in the group in real time;

a refreshing module used for refreshing the ordering information and sending the refreshed ordering information to ordering pages of the client sides.

In a first embodiment of the present invention, the QR code generation method comprises the steps of:

S1, generating a QR code according to a preset unique code, specifically, a web link is obtained by combining a preset domain name with the unique code, and the web link is compiled into the QR code;

S2, setting information corresponding to the unique code, specifically, the unique code is set as a major key of a preset data table, and the value of a field corresponding to the unique code is set.

For example, if the domain name is www.diancai.com and the unique code is ASKDIEOW12, the web link is www.diancai.com/ASKDIEOW12, and the web link is compiled into the QR code. A user can print out the QR code and paste the QR code onto the corresponding position such as a dining table and a cashier desk. The user can bind information with the QR code according to requirements, for example, a menu is input in an ordering code, and the fixed payment is set on a payment code for a self-service restaurant.

Users can be provided with corresponding services by scanning the QR code through the client sides, merchants can provide corresponding services for users just by providing OR codes for users in a paper form or in an electronic form, in this way, the operating cost is greatly reduced, hardware equipment at a high cost does not need to be purchased, APPs do not need to be downloaded either, and the most convenient operation mode conforming to using habits of users in the current society is provided.

In a second embodiment of the present invention, the QR code generation method includes the steps of:

S1, generating a QR code according to a preset unique code, specifically, a web link is obtained by combining a preset domain name with the unique code, and the web link is compiled into the QR code;

wherein, information carried by the QR code is www.diancai.com/ASKDIEOW13.

S2, setting information corresponding to the unique code, specifically, the unique code is set as a major key of a preset data table, the value of a field corresponding to the unique code is set, and the field includes a payment field;

wherein, when a manager of a self-service restaurant scans the QR code through a client side, a server searches a preset data table for corresponding records according to the unique code ASKDIEOW13, a new record is established with the unique code ASKDIEOW13 as the major key if no corresponding record is searched for, and the value of the payment field is set. In this way, when a customer in the self-service restaurant scans the QR code, the payment can be recognized automatically, and the payment interface is shown automatically for executing corresponding payment.

S3, updating the value of the payment field corresponding to the unique code;

wherein, when the self-service restaurant changes prices, the value of the payment field corresponding to the QR code can be modified in a database, and the corresponding QR code does not need to be regenerated. QR codes can be inlaid in posters, decorations or menus of the restaurant, and the worry of remanufacturing cased by price adjustment is avoided. The utilization rate of the QR code is increased.

In a third embodiment of the present invention, the QR code generation method includes the steps of:

S1, generating a QR code according to a preset unique code, specifically, a web link is obtained by combining a preset domain name with the unique code, and the web link is compiled into the QR code;

wherein, information carried by the QR code is www.diancai.com/ASKDIEOW14.

S2, setting information corresponding to the unique code, specifically, the unique code is set as the major key of a data table, the value of a field corresponding to the unique code is set, and the field includes a restaurant name field and a table number field;

wherein, multiple QR codes can be generated by the manager of the restaurant at a time and are printed to be pasted on dining tables, and then table number fields corresponding to the QR codes are bound according to the dining table numbers. In the prior art, a QR code corresponding to a table number is generated and then pasted onto the corresponding dining table, the QR code is likely to be pasted mistakenly when pasted, and consequentially the situation that the QR code does not correspond to the dining table information is caused.

S3, grouping client sides scanning the same QR code;

wherein, when multiple client sides scan the QR code on the same dining table, a system can call historical records to judge whether the client sides used to have dinner on the same table or not; if not, the users will be asked to confirm whether a table-sharing mode needs to be adopted or not, and the users take orders independently in the mode after confirmation; otherwise, the client sides scanning the same QR code are grouped, the users sharing the same table be in information interaction, such as real-time refreshing of ordering information and game interaction, through the client sides.

S4, counting the client sides in the group, acquiring historical ordering records of the client sides in the group, and pushing menus to the client sides according to the number of the client sides and the historical ordering records, wherein each menu includes dishes and quantities of the dishes;

S5, acquiring ordering information of the client sides in the group in real time, and refreshing the ordering information and sending the refreshed ordering information to ordering pages of the client sides;

wherein, the ordering condition of the users on the same table can be seen in real time, proper dishes and proper dish quantities can be pushed according to the ordering records and the number of the members in the group, and ordering records of other users in the same restaurant and evaluation on dishes can be checked for reference for ordering, so that the users are greatly assisted in selecting proper dishes, and user experience is improved.

S6, acquiring ordering records corresponding to the value of the restaurant name field and the value of the table number field, and generating a bill according to the value of the restaurant name field, the value of the table number field and the ordering records.

According to the above description, by adoption of the code-scanning ordering way, the cost is greatly reduced for merchants. By adoption of the same-table ordering way, all users can participate in ordering, the communication time for ordering is shortened, and the ordering efficiency is improved. Since table-sharing ordering and same-table ordering can be switched freely, requirements of restaurants of different types are met. Corresponding dishes are pushed according to the historical ordering records of users. By browsing the ordering records and dining evaluation of other users, users can select dishes with the proper tastes relatively accurately during ordering. User-friendly self-service ordering can be achieved to the maximum extent through the functional design, and ordering is convenient.

In conclusion, according to the QR code generation method and system provided by the present invention, the QR code is generated according to the preset unique code firstly, then corresponding information is bound with the QR code according to user requirements, and thus the QR code can be used more conveniently. In addition, the same QR code can be reused to realize different functions by unbinding or updating information corresponding to the QR code, and thus the utilization rate of the QR code is increased.

The foregoing description is only embodiments of the present invention and does not limit the patent scope of the present invention, and all equivalent transformations made according to the content of the description and accompanying drawings of the present invention or direct or indirect applications of the present invention in relevant technical fields are included in the protection scope of the patent of the present invention.

1. A QR code generation method, comprising the steps of:
generating a QR code according to a preset unique code; and
setting information corresponding to the unique code.

2. The QR code generation method according to claim 1, wherein the process of generating the QR code according to the preset unique code comprises:
acquiring a web link by combining a preset domain name with the unique code; and
compiling the web link into the QR code.

3. The QR code generation method according to claim 1, wherein the process of setting information corresponding to the unique code comprises:
setting the unique code as a major key of a preset data table; and
setting the value of a field corresponding to the unique code.

4. The QR code generation method according to claim 1, further comprising:
grouping client sides scanning the same QR code.

5. The QR code generation method according to claim 4, further comprising:
counting the client sides in the group;
acquiring historical ordering records of all the client sides in the group; and
pushing menus to the client sides according to the number of the client sides and the historical ordering records, wherein each menu includes dishes and quantities of the dishes.

6. The QR code generation method according to claim 4, further comprising:
acquiring ordering information of the client sides in the group in real time;
refreshing the ordering information and sending the refreshed ordering information to ordering pages of the client sides.

7. The QR code generation method according to claim 2, wherein the field includes a payment field;
the value of the payment field corresponding to the unique code is updated.

8. The QR code generation method according to claim 1, wherein the field includes a restaurant name field and a table number field, the method further comprising;
ordering records corresponding to the value of the restaurant name field and the value of the table number field are acquired; and
generating a according to the value of the restaurant name field, the value of the table number field and the ordering records.

9. A QR code generation system, comprising:
a generation module used for generating a QR code according to a preset unique code; and
a setting module used for setting information corresponding to the unique code.

10. The QR code generation system according to claim 9, further comprising:
an establishment module used for grouping client sides scanning the same QR code;
a counting module used for counting the client sides in the group;
a first acquisition module used for acquiring historical ordering records of the client sides in the group;
a pushing module used for pushing menus to the client sides according to the number of the client sides and the historical ordering records, wherein each menu includes dishes and quantities of the dishes;
a second acquisition module used for acquiring ordering information of the client sides in the group in real time; and
a refreshing module used for refreshing the ordering information and sending the refreshed ordering information to ordering pages of the client sides.
